(19) United States
(12) Patent Application Publication
(10) Pub. No.: US 2010/0263007 A1
(43) Pub. Date: Oct. 14, 2010

(54) Method and Apparatus for Increasing Quality of IPTV Transmission

(76) Inventors: Jinyun Zhang, Cambridge, MA (US); Yige Wang, Natick, MA (US); Bo Rong, Montreal (CA)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/421,474

(22) Filed: Apr. 9, 2009

(51) Int. Cl. H04N 7/173; H04L 12/56

(52) U.S. Cl. 725/110; 370/389

(57) ABSTRACT

In a home network for Internet protocol (IP) television (IPTV), a controller of an IPTV-set-top box (STB) acquires and analyzes of an operation of the home network and data packets in the network. In a home gateway (HG), the statistics are received, and the packets are decoded, and then encodes into data packets, repair packets and according to the statistics to decrease packet loss. That is, the encoded packets have additional error correction codes.

### FIELD OF THE INVENTION

This invention relates generally to Internet protocol television (IPTV) in a home network, and more particularly to using application layer forward error correction (AL-FEC) to increase the quality of IPTV.

### BACKGROUND OF THE INVENTION

Internet Protocol Television

Internet protocol television (IPTV) provides television contents using the Internet protocol (IP) instead of using conventional broadcast and cable channels. IPTV is typically bundled with other services such as Video on Demand (VOD), Voice over IP (VOIP), or digital phone using Internet access, collectively referred to as “triple play.”

IPTV has a number of unique features. In a conventional TV network, all available content is continuously transmitted to each customer. Then, the customer selects the specific content to watch. This consumes network bandwidth, e.g., 6 MHz per channel or 600 MHz for a 100 channel cable network.

In IPTV, only the content selected by the customer is transmitted. Moreover, IPTV has the ability for digital video recorders (DVRs) to concurrently record broadcasts. It also allows customers to have picture-in-picture (PIP) viewing without leaving the current program. IPTV also used packets, which enable error correction, which is not available for conventional TV signals.

Forward Error Correction

With forward error correction (FEC), the sender adds an error-correcting code (ECC) to the packets to be transmitted. Then, the receiver can detect and correct a most errors. One important class of FEC includes linear block error-correcting codes. In general, FEC is used at data link and physical layers of the International Organization for Standardization (ISO) protocol stack to reduce packet loss and ensure a certain Quality-of-Service (QoS) for all content.

Application Layer Forward Error Correction

One challenge for high-quality IPTV services is to reduce noticeable artifacts caused by packet loss. To achieve a high quality, application layer forward error correction (AL-FEC) can be used, in addition to the FEC protection at the link and physical layers.

FIG. 2 shows a general concept of AL-FEC encoding and decoding. In a transmitter 210, every k source packets 211 are encoded into n (n>k) packets, which include the k data packets and n−k repair packets 213, through a FEC encoder 212. The data and repair packets are transmitted through a channel 220, which can be in any network. Due to network conditions, some packets 231 are lost during transmission. At the receiver 230, the FEC decoder 232 makes use of all the packets received to recover the lost source packets.

For an optional protocol for AL-FEC protection of streaming media for IPTV services carried over Real-time Transport Protocol (RTP), see ETSI TS 102 034 v1.3.1, “Transport of MPEG 2 Transport Stream (TS) Based DVB Services over IP Based Networks,” DVB Blue Book A086rev5, and M. Luby, T. Stockhammer, and M. Watson, “IPTV Systems, Standards and Architectures: Part II Application Layer FEC in IPTV Services,” IEEE Communications Magazine, pp. 94-101, May 2008.

In ETSI TS 102 034, the AL-FEC protocol applies a layered structure as shown in FIG. 3, where a source stream includes data packets 315, an AL-FEC stream of repair packets 320 encoded by a simple repair packet-based interleaved parity code, i.e., Society of Motion Picture and Television Engineers (SMPTE) 2022-1 code 320, and an AL-FEC stream of raptor packets 330 encoded by a raptor code. Raptor codes are one class of fountain codes with linear time encoding and decoding. In the receiver 340, a decoder 350 is used for decoding the packets to recover the source stream 310.

Interleaved Parity Code (SMPTE 2022-1 code)

FIG. 4 shows the encoding process of the interleaved parity code (SMPTE 2022-1 code). A source block 440 with DP source packets 211 is arranged into D rows and P columns. The period chosen between data packets covered by the same SMPTE repair packet 430 is P. The D data packets in each column 410 go through an exclusive-OR (XOR) block 420 to generate a SMPTE repair packet 430.

If any data packet is lost during transmission, SMPTE 2022-1 decoding is performed. If only one data packet is missing in one column and the corresponding repair packet is received, then this missing data packet can be recovered by exclusive-ORing the repair packet with the data packets in this column.

FIG. 5 shows the header format of repair packets. Several fields are described as follows. SNBase low bits 510 is the minimum sequence number of the source packets associated to the repair packet. Offset 520 and NA 530 represent parameter P and D, respectively.

For details about the SMPTE 2022-1 code, see SMPTE specification 2022-1, “Forward Error Correction for Real-time Video/Audio Transport Over IP Networks.”

Raptor Codes

Raptor codes are one kind of fountain codes. Fountain codes are also known as rateless erasure codes and they belong to linear block codes. Raptor codes have the property that for a fixed number of data symbols, the number of encoding symbols (including both data and repair symbols) can be potentially limitless, and the data symbols can be recovered from any subset of the encoding symbols of size equal to or slightly larger than the number of data symbols, see U.S. Pat. No. 6,307,487.

Although LT-codes have excellent performance, they do not have constant encoding and linear decoding complexity without compromising error performance. Raptor codes are an extension of LT-codes, which overcome this drawback, see U.S. Pat. Nos. 6,307,487 and 7,139,960.

The raptor code used in IPTV standard is a systematic linear block code. The property of systematic codes is that their code-words can be partitioned into two parts, one containing the unaltered data symbols and the other containing repair symbols. Unless specified otherwise, any reference to “raptor codes” herein refers to systematic raptor codes.

In order to apply the raptor encoder to data packets, the source packets can be partitioned into blocks. The raptor encoder is applied independently to each block. Each block is identified by a unique integer Source Block Number (SBN). Each block is partitioned into K source symbols. Each source symbol is identified by a unique integer Encoding Symbol Identifier (ESI).

Each encoding packet includes data symbols or repair symbols. The Encoding Symbol ID, X, in each data or repair packet is the Encoding Symbol ID of the first data or repair symbol carried in that packet. The subsequent data or repair symbols in the packet have Encoding Symbol IDs, X+1 to X+G−1, in sequential order, where G is the number of symbols in the packet. A packet may contain any number of symbols for the same block.

FIG. 6 shows the encoding process of the raptor code. First, an intermediate block 630 with L intermediate symbols 631 (L>K) is generated from a block 610 of K data symbols 611 through an intermediate symbol generator 620. Let C=(C[0], . . . , C[K−1]) denote the source block and E=(E[0], . . . , E[L−1]) denote the intermediate block. Through an LT-encoder 640, the intermediate block 630 is encoded to an encoding block 650, which contains unchanged source symbols 611 and some repair symbols 651. Both source data symbols and repair symbols are called encoding symbols.

There are “pre-coding relationships” between the last L−K and the first K intermediate symbols. The pre-coding relationships are

G_{pre-coding}·E=0, (1)

where G_{pre-coding} is an (L−K) by L binary matrix and 0 is a column vector of length (L−K).

In the binary matrix, the elements are 0 or 1, and · denotes matrix multiplication over a Galois field of two elements GF(2). An example binary matrix is

$$[ \begin{matrix}1 & 1 & 0 \\ 0 & 1 & 1\end{matrix} ] ,$$

and if

$$[ \begin{matrix}β \\ γ\end{matrix} ] = [ \begin{matrix}1 & 1 & 0 \\ 0 & 1 & 1\end{matrix} ] \cdot [ \begin{matrix}a \\ b \\ c\end{matrix} ] , then$$

β=a+b and γ=b+c.

As shown in FIG. 6, K source data symbols can be obtained from L intermediate symbols through an LT-encoder. Because LT codes are linear block codes, L intermediate symbols and K source data symbols can be related by a K×L binary matrix G_{LT}, i.e.,

C=G_{LT}·E, (2)

Let D denote the column vector consisting of L−K zero symbols followed by the K source data symbols. Define a matrix A over the GF(2) as

$$A = [ \begin{matrix}{G}_{pre \text{-} coding} \\ {G}_{LT}\end{matrix} ] . \qquad ( 3 )$$

Then,

A·E=D. (4)

The intermediate symbols are

E=A⁻¹·D. (5)

Matrix A is full rank and invertible.

After the intermediate symbols 631 have been generated, repair symbols 651 are produced by LT encoder 640. We denote repair symbols by

R=(R[0], R[1], . . . , R[J−1]),

where J is the number of repair symbols generated. Then L intermediate symbols and J repair symbols can be related by a J×L binary matrix G′_{LT}, i.e.,

R=G′_{LT}·E. (6)

One or more repair symbols are grouped to form a repair packet.

The decoding process is described as follows. Let V≧K be the number of received encoding symbols for a source block and let M=L−K+V. Let D′ be the column vector of M symbols with values known to the receiver, where the first L−K of the M symbols have values of zeroes, and the remaining V of the M symbols are the received encoding symbols for the source block.

An M by L binary matrix A′ can be generated based on the received encoding symbols, which is composed of three parts. The first part of A′ is G_{pre-coding}. The second part of A′ contains rows in G_{LT} that correspond to the received source symbols. For example, if the 1^{st}, 3^{rd}, 5^{th}, . . . , source data symbols are received at the receiver, then the 1^{st}, 3^{rd}, 5^{th}, . . . , rows of G_{LT} are selected. The third part of A′ contains rows in G′_{LT} that correspond to the received repair symbols. Then

A′·E=D′. (7)

Decoding a source block is equivalent to solving E from A′ and D′. If and only if the rank of A′ is L, then E can be decoded and the missing source data symbols can be recovered using equation (4).

For more detailed information about raptor encoding and decoding, see ETSI TS 102 472, “Digital Video Broadcasting (DVB); IP Datacast over DVB-H: Content Delivery Protocols.”

Decoding of AL-FEC for IPTV

Decoding is carried out at the receiver side as follows:

Step 1: SMPTE 2022-1 decoding. In this step, SMPTE 2022-1 decoding is used and all missing data packets are not recovered, go to Step 2.

Step 2: raptor decoding. In this step, the raptor repair packets, together with the received data packets and any data packets which were recovered in Step 1, are processed using standard raptor decoding procedures (as described above) to recover more data packets. If there are still missing data packets after raptor decoding, perform Step 3.

Step 3: Decoding. In this step, the unprocessed SMPTE 2022-1 packets are converted to a form in which they can be added to the raptor decoding process, and raptor decoding continues. For details of the decoding, see ETSI TS 102 034 v1.3.1, “Transport of MPEG 2 Transport Stream (TS) Based DVB Services over IP Based Networks,” DVB Blue Book A086rev5, Oct. 2007.

### MOTIVATION OF THE INVENTION

Although current AL-FEC schemes can effectively reduce packet loss, for some home networks, especially wireless networks, additional packet loss will occur after the packet enters the home network. The packet loss at the end devices could be more severe than expected sometimes. In this case, packets reaching the home gateway (HG) from the IP network are sufficient to recover all the source information, but IPTV-STB can not do so because of considerable packet loss within the home network.

To solve this problem, QoS enhancement is required. A QoS-adjustable home gateway is described by S. Lee, C. Cho, and I. Han, “QoS-adjustable home gateway for IPTV service,” ICCE, January 2005, pp. 395-396. They describe changing priority level of received data streams and do not deal with packet loss within home network. One solution to the problem is that the receiver 340 can request the source 310 to send additional FEC, see US Patent Publications 20080028279, 20080028280.

However, the source is often far away from IPTV-STB, and communicating with the source causes delays. Thus, a scheme for reducing packet loss and that operates entirely in the home network is desired.

### SUMMARY OF THE INVENTION

This invention operates in an error-prone home network, especially, when additional packet loss is caused by the home network so that source data can not be totally recovered by the IPTV-STB using error control codes embedded in the transmitted packets.

The embodiments of the invention provide QoS enhancement components for both the home gateway (HG) and the STB, and enable the STB to send the HG statistics signals, which characterize an operation of the home network, and the packets. If the home network has severe packet loss and the quality of IPTV services can not meet requirements, then the QoS enhancement components is activated.

The embodiments of the invention use real-time transport control protocol (RTCP) for STB to transmit the feedback signal to the HG. RTCP is related to real-time transport protocol (RTP). The RTCP provides out-of-band control information for an RTP flow, and also feedback on the QoS provided by the RTP.

The QoS enhancement components in the HG and the STB have a layered structure. The first layer enhancement is to add more protection to the SMPTE repair packets. And the second layer adds more protection to the raptor packets. When QoS enhancement components are activated, one or more appropriate layers are selected based on the statistics fed back from the STB.

### BRIEF DESCRIPTION OF THE DRAWINGS

FIG. 1 is a block diagram of an IPTV network and home network according to embodiments of the invention;

FIG. 2 is block diagram of a conventional application layer FEC;

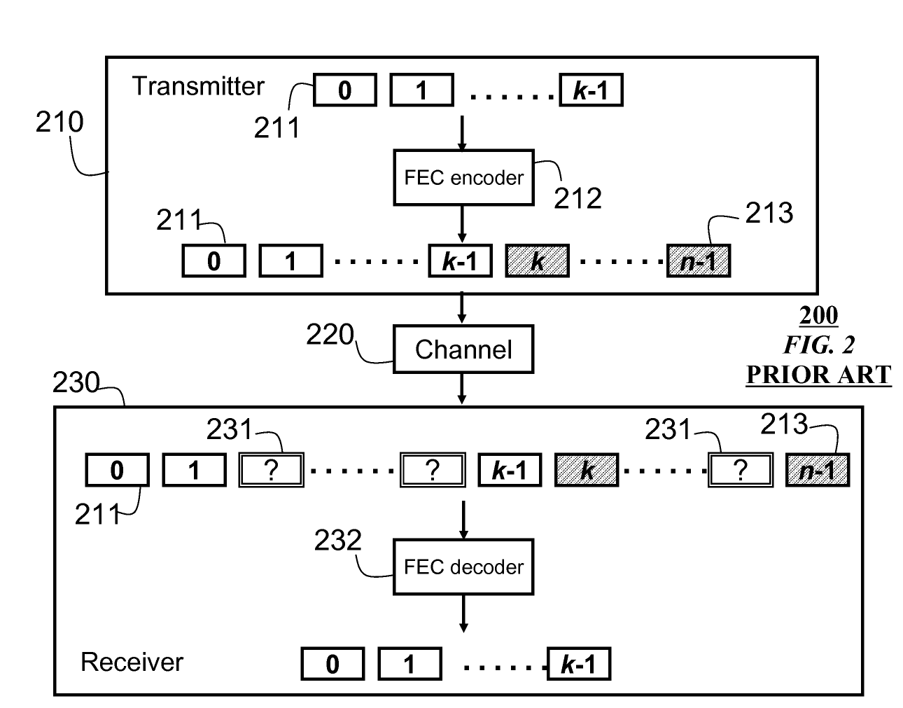

FIG. 3 is block diagram of a conventional layered AL-FEC based IPTV transmission network;

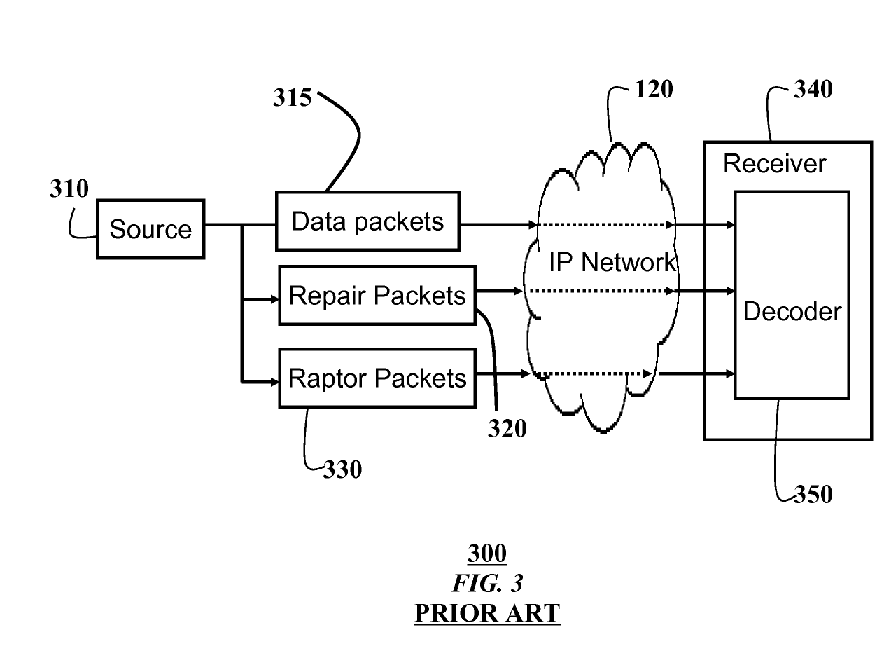

FIG. 4 is a block diagram generation of SMPTE 2022-1 repair packets;

FIG. 5 is a block diagram of a conventional of the FEC header format of SMPTE 2022-1 repair packets;

FIG. 6 is a block diagram of generation of conventional raptor encoding symbols;

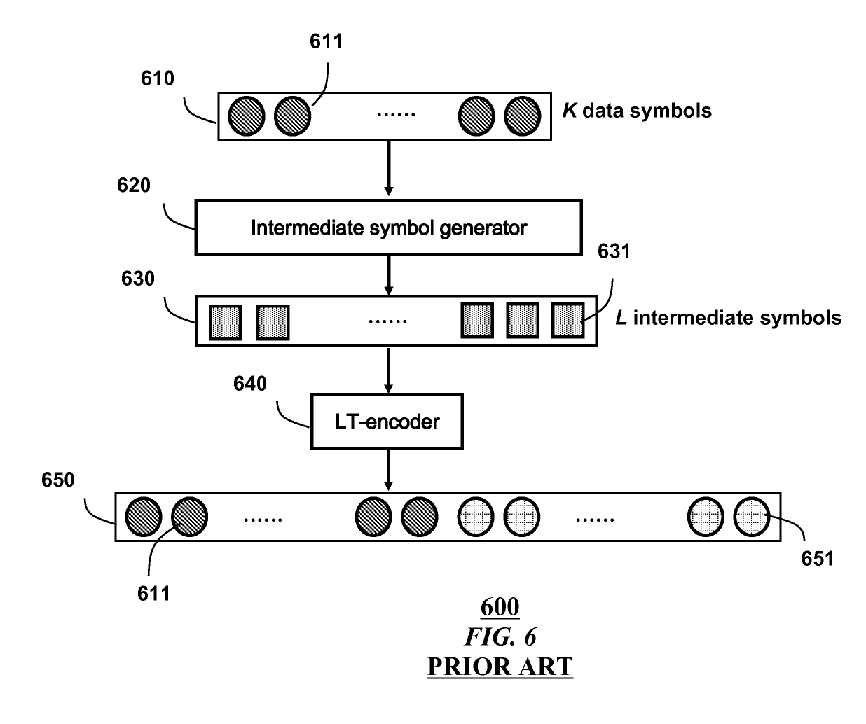

FIG. 7 is a block diagram of a home gateway and IPTV-STB according to an embodiment of the invention;

FIG. 8 is a block diagram of QoS enhancement components in HG according to an embodiment of the invention;

FIG. 9 is a block diagram of the HG QoS enhancement encoder according to an embodiment of the invention;

FIG. 10 is a block diagram of a first layer enhancement encoder in the HG QoS enhancement encoder according to an embodiment of the invention;

FIG. 11 is a block diagram of a second layer enhancement encoder in the HG QoS enhancement encoder according to an embodiment of the invention;

FIG. 12 is block diagram of a structure of a payload ID of enhancement packets according to an embodiment of the invention; and

FIG. 13 flow diagram of QoS enhancement in IPTV-STB according to an embodiment of the invention.

### DETAILED DESCRIPTION OF THE PREFERRED EMBODIMENT

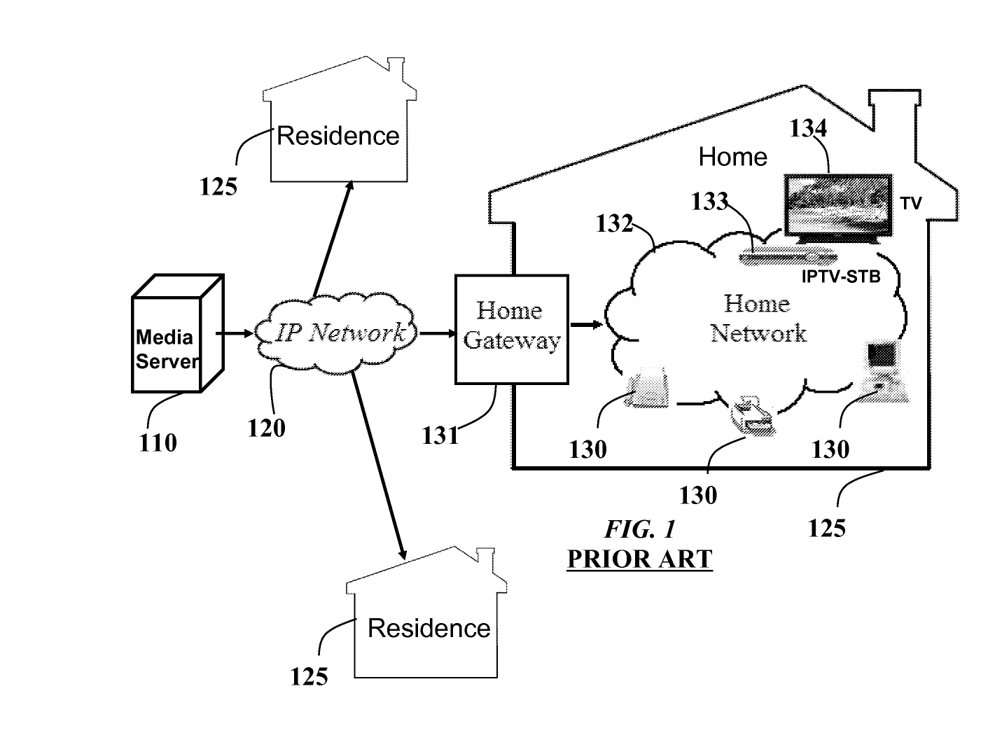

FIG. 1 shows an IPTV network that uses embodiments of our invention. A home gateway (HG) 131 is an interface in a residence 125 for connecting network devices 130 to an IP network 120 including a multi-media server 110. As used herein, residence can be a home, apartment, or even a temporary residences, such as a hotel, hospital, or anywhere where people can reside and desire access to multi-media content, e.g., television programs, web content, or telephone service.

The interface acts as a router, which distributes different services to corresponding devices. IPTV multi-media content is forwarded from the gateway through a residence network 132 via wireless or wired connections, then received and processed by an IPTV set-top box (IPTV-STB) 133, and displayed on, e.g., a TV 134.

The home network 132 is a local area network (LAN), which connects the devices 130 in the residence 125 through wireless LAN, cables, fiber optics or other possible media. The IPTV-STB 133, e.g., decodes the content for display on the TV. The IPTV-STB also provides two-way communication, which makes video-on-demand (VOD) and other interactive services possible.

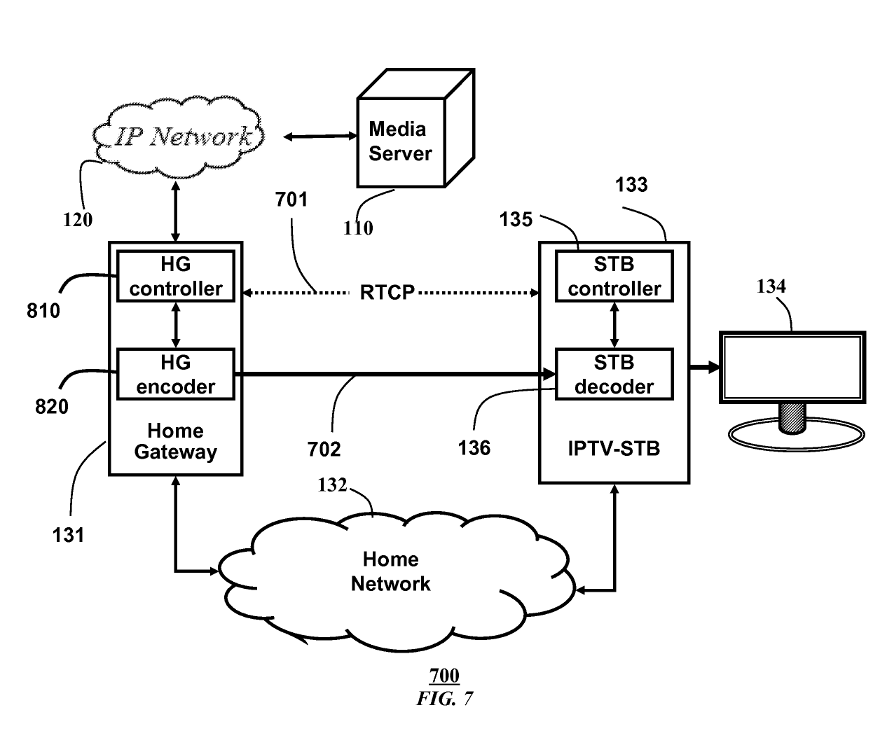

FIG. 7 shows communications between the Internet network 120, and the home network 132 using the home gateway (HG) 131. The home network is connected to then Internet protocol television set-top box (IPTV-STB) 133. The IPTV-STB 133 includes a STB controller 135. The STB controller acquires and analyzes statistics of an operation of the home network, and the IPTV-STB feeds back 701 the statistics to the gateway 131.

The IPTV-STB makes use of real-time transport protocol (RTPC) 701 to transmit the statistics to the HG 131. The RTCP is defined in Request for Comment (RFC) 3550, which supersedes RFC 1889 of the Internet Official Protocol standard.

The statistics characterize on operation of the home network 132 as well as the packets received by the IPTV-STB, such as bytes sent, packets sent, lost packets, jitter, and round trip delay. A HG controller 810 of the HG analyzes the statistics information, and determines what kind of data packets 702 to send to IPTV-STB, and from there to home network devices, such as the television 134.

As described in greater detail below, the home network be subject to low, medium and high error rates, i.e., LL<MM<HH. If the error rate is low, then only source packets are sent. If the error rate is medium, then enhancement repair packets are also sent. If the error rate is high, the HG also sends enhancement raptor packets.

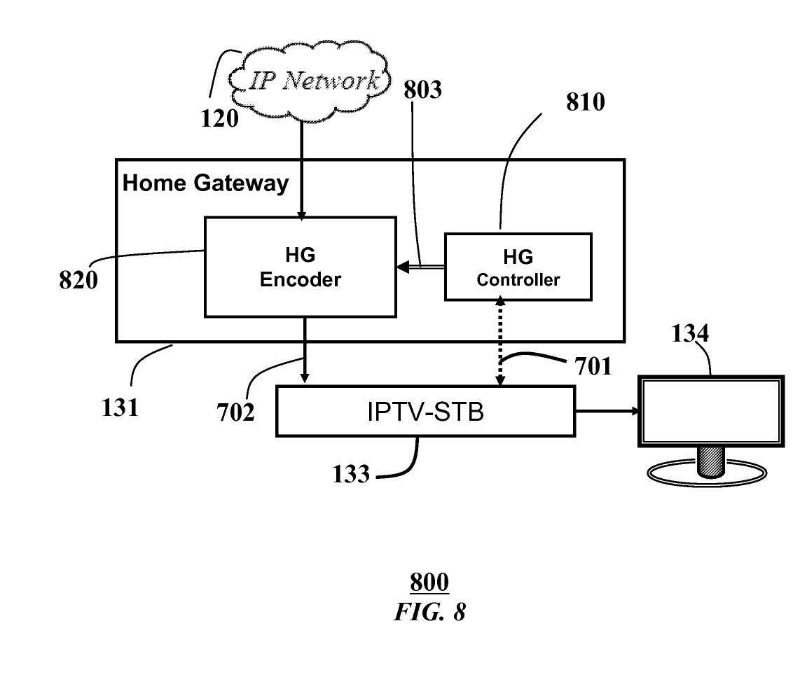

FIG. 8 shows the details of the HG 131 with QoS enhancement components. The HG includes a HG controller 810. The controller receives and analyzes the statistics received from the IPTV-STB. Then, the HG sends an HG encoder 820 a control signal 803. The control signal indicates if the QoS enhancement function should be activated, and which enhancement layer(s) should be used. If the IPTV-STB 133 the packet loss is relatively low LL, then only the source packets are sent. If the packet loss is medium MM, then enhancement repair packets are also sent. If the packet loss is high HH, then enhancement raptor packets are also sent.

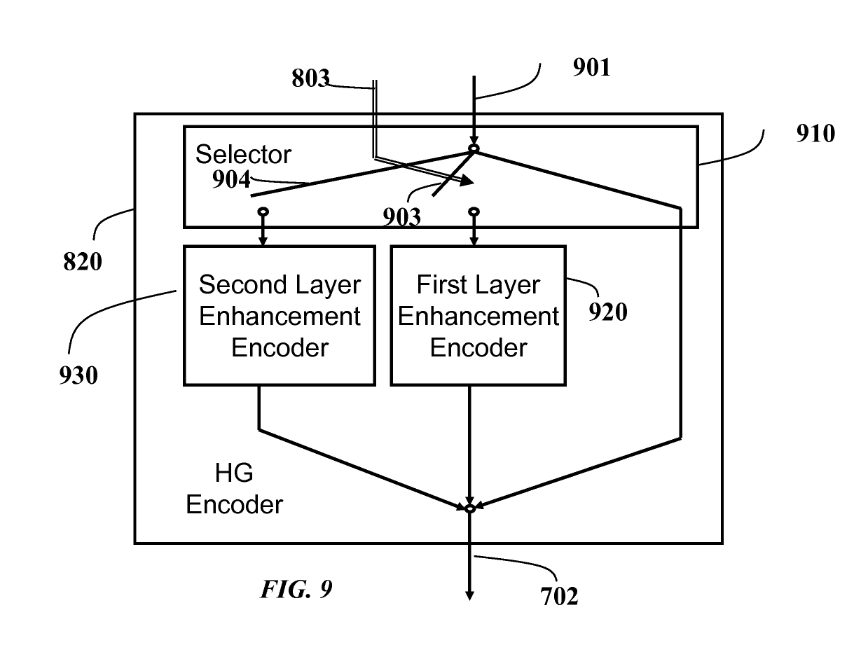

As shown in FIG. 9, the QoS enhancement encoder 820 contains a selector 910, a first layer enhancement encoder 920, and a second layer enhancement encoder 930. The selector is controlled by the control signal 803 from the controller 810.

The source, repair, and raptor packets 901 are always forwarded to the output 702 of the QoS enhancement encoder. When switch 903 is closed, the first layer enhancement encoder 920 is activated to send SMPTE 2022-1 enhancement repair packets. When switch 904 is closed, a second layer enhancement encoder 930 is activated to send enhancement raptor packets.

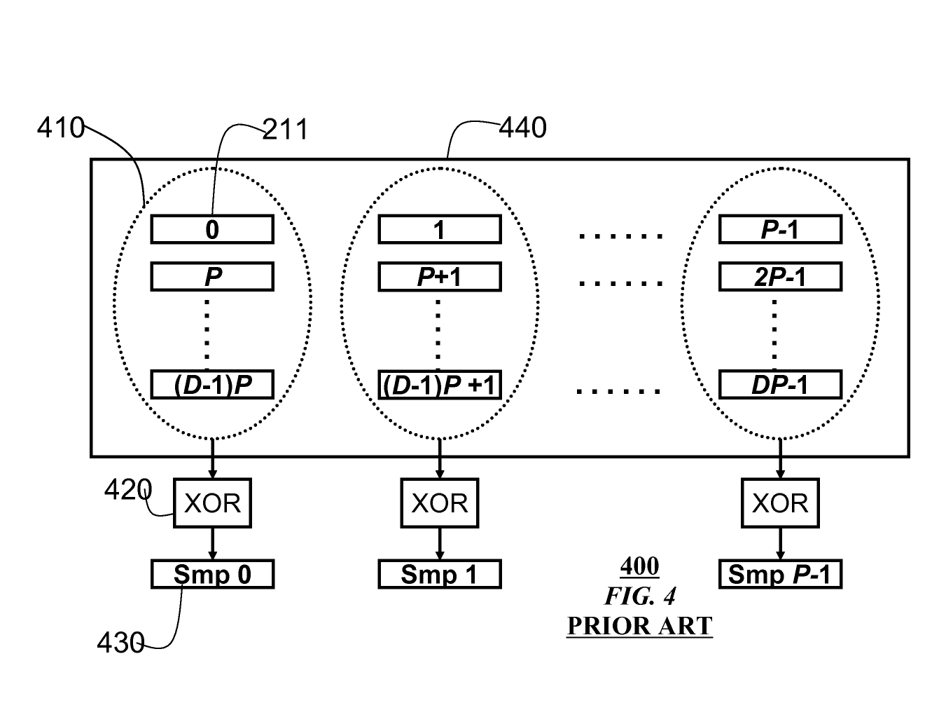

As shown in FIG. 4, in SMPTE 2022-1 encoding process, a source block with DP packets is arranged into a D by P array, where P has a factor of f and P/f=r.

In our first layer enhancement encoder 920, a buffer collects SMPTE 2022-1 repair packets and checks the SNBase low bits field in the header of the packets. Regard packets with SNBase low bits values i, i+f, i+2f, . . . , i+(r−1)f, where i<f, as a set. Then there are f such sets that are disjoint.

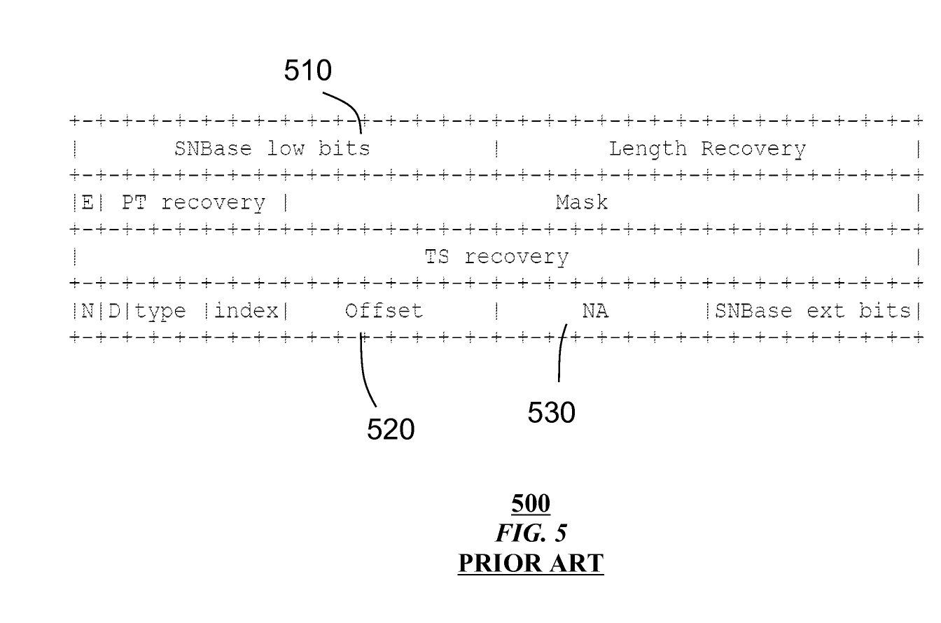

If all the r packets in the same set have been stored in the buffer, the packets are exclusive-ORed to generate our enhancement repair packet. The FEC header of our enhancement repair packet is the same as that of the SMPTE 2022-1 repair packet with the smallest SNBase low bits value in this set, except that the Offset field 520 is changed to f and the NA field 530 is changed to Dr, see FIG. 5. Because of our novel arrangement, our new enhancement repair packet can be regarded as an exclusive-OR of a column in an f by Dr array of the source block. If any packet in a set is not received by home gateway, then the corresponding new enhancement repair packet is not generated.

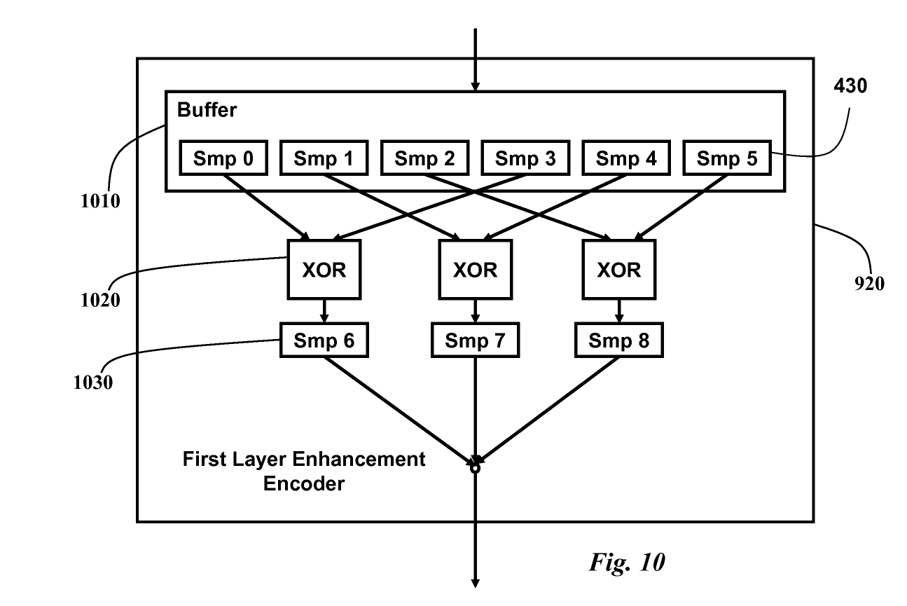

FIG. 10 shows the details of the first layer enhancement encoder 920 for a source block with eighteen source packets, where D=3 and P=6, i.e., there are six repair packets transmitted. All the repair packets are received and stored in the buffer 1010. Set f=3 and r=2. Based on our design, packets with SNBase low bits values 0 and 3 go through an XOR block 1020 and a new enhancement repair packet 1030 is generated. Similarly, packets with SNBase low bits values 1 and 4 are combined, and packets with SNBase low bits values 2 and 5 are combined. The SNBase low bits field in the FEC header of these new packets is set to 0, 1, and 2, respectively. The Offset field 520 is set to 3 and the NA field 530 is set to 6.

Because our additional enhancement repair packets 1030 generated by the first layer enhancement encoder 920 are compatible with the current SMPTE 2022-1 decoder, the STB can decode our new enhancement repair packets.

If error rate in the home network is relatively high, then the second layer enhancement encoder 930 is also activated. The second layer enhancement encoder also uses a buffer to store the received raptor encoding packets (including source and repair packets).

The buffer arranges the received raptor packets in a Q by y array. Then, the Q raptor packets in the same column are XORed to generate a new enhancement raptor packet. This arrangement can effectively reduce the burst errors in the home network. Because the raptor packets do not necessarily have the same size, the smallest size of the packets that participate in the XOR operation is selected as the size of the corresponding enhancement raptor packet. For the raptor encoding packets with larger size, their extra symbols are not involved in the XOR operation.

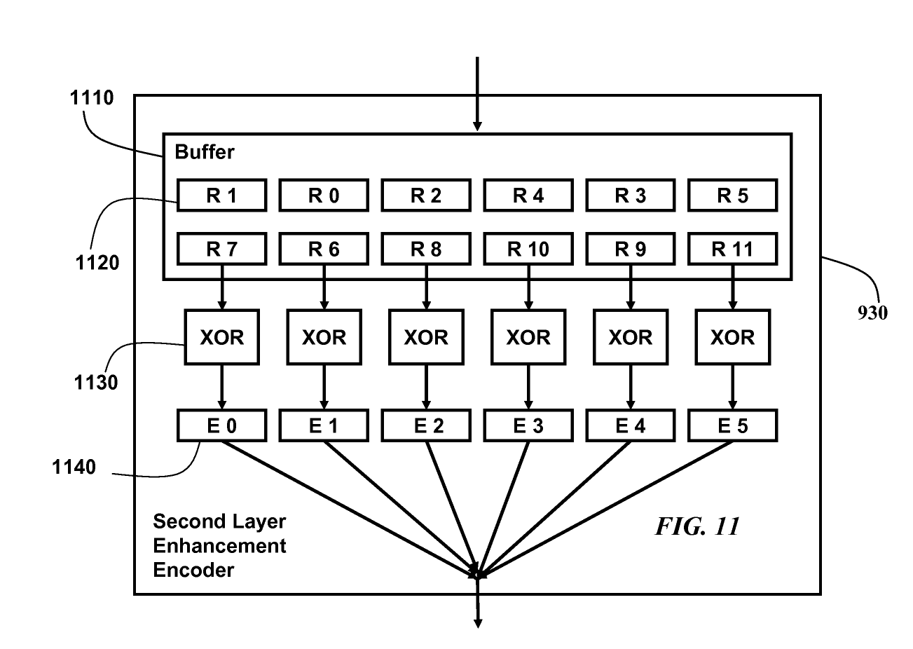

FIG. 11 shows the structure of the details of the second layer enhancement encoder 930. The received raptor encoding packets 1120 are stored in a buffer 1110, which has a size of twelve in this example, The received raptor packets are arranged into a 2×6 array. The raptor packets 1120 in the same column go through an XOR block 1130 to generate an enhancement raptor packet 1140. Then six enhancement raptor packets 1140 are sent sequentially to the STB.

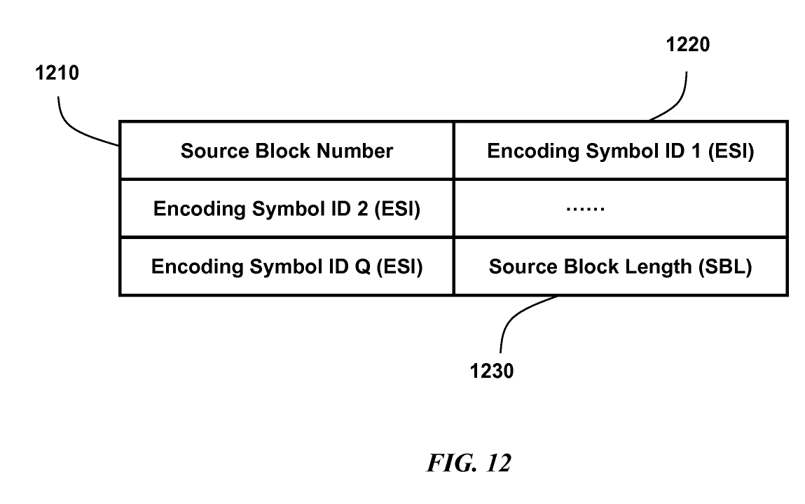

FIG. 12 shows the structure of payload ID of our enhancement raptor packet. The 16-bit field Source Block Number (SBN) 1210 indicates an integer identifier for the source block 610 that relate to the symbols in the enhancement raptor packet. The next Q 16-bit fields 1220 are Encoding Symbol ID (ESI) of the Q raptor encoding packets 1120, which generate this enhancement packet. Encoding Symbol ID (ESI) represents the integer identifier for the encoding symbols in a raptor encoding packet. The last 16-bit field is Source Block Length (SBL) 1230, which gives the number of source symbols 611 in the source block 610.

The IPTV-STB 133 has an additional process to deal with enhancement raptor packets 1140.

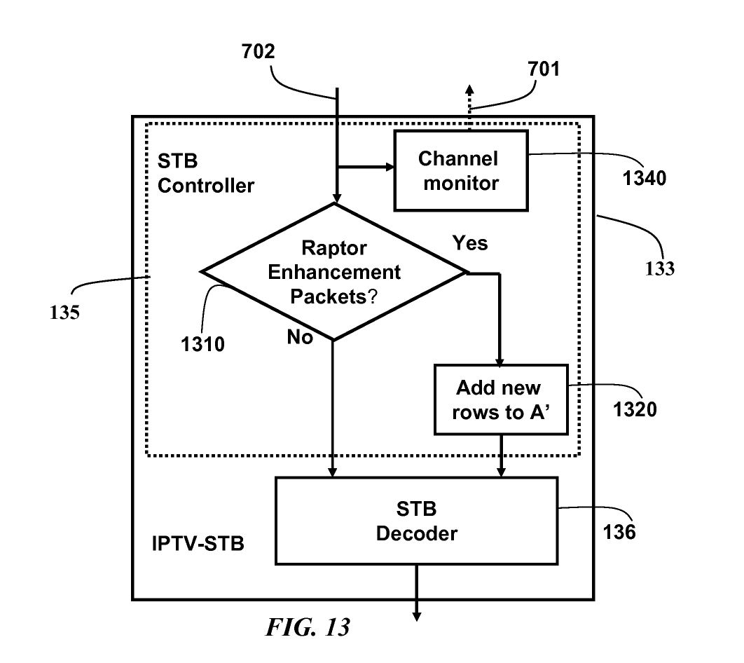

FIG. 13 shows the details of the structure of IPTV-STB 133 with QoS enhancement components. The IPTV-STB includes a channel monitor 1340, which receives the stream of packets 702 from HG and sends out feedback signals 701. For the input stream 702, The STB first checks 1310 if a received packet is an enhancement raptor packet. If it is, then new rows are added to the decoding matrix A′; otherwise, the received packet is forwarded to the STB decoder 136.

If the number of received enhancement packets is Nₑ and the number of symbols in each enhancement raptor packet is Wᵢ for 0≦i≦Nₑ−1, then, the j^{th} symbol in the enhancement raptor packet i is e_{i,j}, where 0≦i≦Nₑ−1 and 0≦j≦Wᵢ.

Let

\tilde{D}=[D′|e_{0,0}e_{0,1}. . . e_{0,W}_{₀}₋₁e_{1,0}e_{1,1}. . . e_{1,W}_{₁}₋₁. . . e_{N}_{ₑ}_{-1,0}. . . e_{N}_{ₑ}_{-1,W}_{_{Ne−1}}₋₁],

i.e., the concatenation of D′ and all the symbols in the received enhancement packets. Because the length of D′ is M, the length of

$$\tilde{D} is M + {\sum }_{i = 0}^{{N}_{e} - 1} {W}_{i} .$$

For each symbol e_{i,j} in \tilde{D}, a new row is added to the matrix to A′. The new row is generated as follows.

Step 1: The row a is initialized to zero.

Step 2: For 1≦l≦Q, the l^{th} Encoding Symbol ID field of enhancement raptor packet i is read out and let it be ESIₗ. If ESIₗ<K, then the (ESIₗ+j)^{th} row in G_{LT} is XORed to a. If ESIₗ≧K, then the (ESIₗ−K+j)^{th} row in G′_{LT} is XORed to a.

After all the new rows are added to A′, a new matrix Ã is generated, which has

$${\sum }_{i = 0}^{{N}_{e} - 1} {W}_{i}$$

more rows compared to A′ and

Ã·E=\tilde{D}. (9)

As long as Ã has a rank at least L, E can be solved. Because Ã has more rows than A′, it has a higher probability to meet the rank requirement.

QoS Enhancement STB Decoding

There are three cases for the STB decoder 136.

Case 1: no QoS enhancement function is activated. In this case, the STB decoder works as specified in the ETSI TS 102 034 standard.

Case 2: only the first layer enhancement encoder 920 is activated. For this case, in Step 1 of STB decoding, both the original SMPTE 2022-1 repair packets 430 and the enhancement repair packets 1030 generated by the first layer enhancement encoder are decoded by the conventional SMPTE 2022-1 decoder. Step 2 is the same as that in ETSI TS 102 034. In Step 3, besides the virtual raptor packet generated by the unprocessed SMPTE 2022-1 repair packets 430, another virtual raptor packet can be produced by the unprocessed new enhancement repair packets 1030. Then raptor decoding continues.

Case 3: both the first and second layer enhancement encoders are activated. For this case, in Step 1 of STB decoding, both the original SMPTE 2022-1 repair packets 430 and the enhancement repair packets 1030 generated by the first layer enhancement encoder are decoded by conventional SMPTE 2022-1 decoder. In Step 2, enhancement raptor packets 1140 are involved in raptor decoding as described above. In Step 3, besides the virtual raptor packet generated by the unprocessed SMPTE 2022-1 repair packets 430, another virtual raptor packet can be produced by the unprocessed enhancement repair packets 1030. Then raptor decoding in Step 2 is continued.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. An apparatus for communicating using Internet protocol (IP) television (IPTV) in a home network, comprising:
an IPTV-set-top box (STB) connected to the home network, comprising:
an STB controller configured to acquired and analyze statistics, wherein the statistics characterize an operation of the home network and data packets, repair packets and raptor packets communicated by the home network; and
an STB decoder connected to the STB controller; and
a home gateway (HG) configures to receive the statistics from the IPTV STB, comprising:
a HG controller configured to receive and analyze the statistics; and
a HG encoder, connected to the HG controller, configured to encode the data packets, the repair packets and the raptor packets, received from an IP network, for the STB decoder according to the statistics to decrease packet loss.

2. The apparatus of claim 1, wherein the IPTV-STB uses a real-time transport control protocol (RTCP) to transmit the statistics to the HG controller.

3. The apparatus of claim 1, wherein the statistics are selected of the group consisting of bytes sent, packets sent, lost packets, jitter, round trip delay, or combinations thereof.

4. The apparatus of claim 1, wherein the HG encoder comprises:
a first layer enhancement encoder configured to encode the repair packets as enhancement repair packets;
a second layer enhancement encoder configured to encode the raptor packets as enhancement raptor packets; and
a switch for selecting the first layer encoder and the second layer encoder according to the statistics.

5. The apparatus of claim 1, wherein the HG sends only the data, repair, and raptor packets, or the data, repair, raptor, and the enhancement repair packets, or the data, repair, raptor, the enhancement repair packets, and the enhancement raptor packets based on the characteristics.

6. The apparatus of claim 5, wherein the first layer enhancement encoder further comprises:
a buffer configured to store a set of repair packets;
applying an exclusive-OR operation on the set repair packets to generate the enhancement repair packets.

7. The apparatus of claim 4, wherein the enhancement repair packet uses the same standard as for the repair packets.

8. The apparatus of claim 7, in which the standard is a Society of Motion Picture and Television Engineers (SMPTE) 2022-1 standard.

9. The apparatus of claim 5, wherein the second layer enhancement encoder further comprises:
a buffer configured to store a set of raptor packets;
applying an exclusive-OR operation on the set raptor packets to generate the enhancement raptor packets.

10. A method for communicating using Internet protocol (IP) television (IPTV) in a home network, comprising the step of:
receiving, in a home gateway (HG), data packets, repair packets and raptor packets of a source data stream;
acquiring and analyzing, in an IPTV-set-top box (STB) connected to the home network, statistics characterizing an operation of the home network and the data packets, the repair packets and the raptor packets communicated by the home network; and
encoding, in the HG, the data packets, the repair packets and the raptor packets to provide additional enhancement repair packets and enhancement raptor packets according to the statistics; and
decoding, in the IPTV STB, the data packets, the repair packets, the raptor packets, and the additional enhancement repair packets and the enhancement raptor packets to recover the source data stream.

11. The method of claim 10, wherein the IPTV-STB uses a real-time transport control protocol (RTCP) to transmit the statistics to the HG.
